(19) United States
(12) Patent Application Publication
(10) Pub. No.: US 2025/0332640 A1
(43) Pub. Date: Oct. 30, 2025

(54) FLOW RATE ADJUSTING DEVICE, THREE-DIMENSIONAL MODELING DEVICE AND INJECTION MOLDING DEVICE

(71) Applicant: SEIKO EPSON CORPORATION, Tokyo (JP)

(72) Inventors: Yasushi KUTSUWADA, MATSUMOTO-SHI (JP); Hiroki KOBAYASHI, HARA-MURA (JP); Yuta SAKAI, SHIOJIRI-SHI (JP); Kazuhide NAKAMURA, ASAHI-MURA (JP)

(73) Assignee: SEIKO EPSON CORPORATION, Tokyo (JP)

(21) Appl. No.: 19/189,171

(22) Filed: Apr. 24, 2025

(30) Foreign Application Priority Data
Apr. 26, 2024 (JP) 2024-072374

(51) Int. Cl. B22F 12/57; B22F 3/22; B22F 12/90; B29C 45/18; B29C 45/77; B29C 64/295; B29C 64/321; B33Y 30/00; B33Y 40/00; B33Y 50/02

(52) U.S. Cl. CPC B22F 12/57; B22F 3/225; B22F 12/90; B29C 45/18; B29C 45/77; B29C 64/295; B29C 64/321; B33Y 30/00; B33Y 40/00; B33Y 50/02; B29C 2945/7604; B29C 2945/7619; B29C 2945/76351; B29C 2945/76531; B29C 2945/76545; B29C 2945/76658; B29C 2945/76829

(57) ABSTRACT

A flow rate adjusting device includes a main body portion including a supply flow path formed with a first opening through which a plasticized material obtained by plasticizing at least a part of a material containing a metal particle is supplied and a second opening through which the plasticized material is ejected, and an intersecting hole intersecting the supply flow path; a tubular sleeve disposed inside the intersecting hole and including a through-hole at a position overlapping the supply flow path; and a shaft-shaped valve unit disposed inside the sleeve, wherein the valve unit includes a concave portion at a position overlapping the supply flow path, and rotates inside the intersecting hole for changing a position of the concave portion, to change a flow path cross-sectional area of the supply flow path for adjusting a flow rate of the plasticized material ejected from the second opening.

The present application is based on, and claims priority from JP Application Serial Number 2024-072374, filed Apr. 26, 2024, the disclosure of which is hereby incorporated by reference herein in its entirety.

### BACKGROUND

### 1. Technical Field

The present disclosure relates to a flow rate adjusting device, a three-dimensional modeling device, and an injection molding device.

### 2. Related Art

JP 2021-754 A discloses a flow rate adjusting device that adjusts a flow rate of a molten material passing through a supply flow path by rotating a valve unit including a concave portion at a position intersecting the supply flow path inside an intersecting hole intersecting the supply flow path through which the molten material flows.

When a plasticized material containing metal particles passes through the supply flow path, the metal particles enter between the valve unit and a sleeve accommodating the valve unit, and thus there was a case where rotation of the valve unit in the sleeve was inhibited.

### SUMMARY

According to a first aspect of the present disclosure, a flow rate adjusting device is provided. The flow rate adjusting device includes a main body portion including a supply flow path formed with a first opening through which a plasticized material obtained by plasticizing at least a part of a material containing a metal particle is supplied and a second opening through which the plasticized material is ejected, and an intersecting hole intersecting the supply flow path, a tubular sleeve disposed inside the intersecting hole and including a through-hole at a position overlapping the supply flow path, and a shaft-shaped valve unit disposed inside the sleeve, wherein the valve unit includes a concave portion at a position overlapping the supply flow path, and rotates inside the intersecting hole for changing a position of the concave portion, to change a flow path cross-sectional area of the supply flow path for adjusting a flow rate of the plasticized material ejected from the second opening, and hardness of a surface of the sleeve facing the valve unit and hardness of a surface of the valve unit facing the sleeve are at least partially different from each other.

According to a second aspect of the present disclosure, a three-dimensional modeling device is provided. The three-dimensional modeling device includes the flow rate adjusting device according to the above first aspect, a plasticizing unit configured to generate the plasticized material by plasticizing at least a part of the material, and a nozzle configured to discharge the plasticized material supplied from the plasticizing unit toward a stage, wherein the flow rate adjusting device adjusts a flow rate of the plasticized material supplied from the plasticizing unit to the nozzle.

According to a third aspect of the present disclosure, an injection molding device is provided. The injection molding device includes the flow rate adjusting device according to the above first aspect, a plasticizing unit configured to generate the plasticized material by plasticizing at least a part of the material, and a nozzle configured to inject the plasticized material supplied from the plasticizing unit into a molding die, wherein the flow rate adjusting device adjusts a flow rate of the plasticized material supplied from the plasticizing unit to the nozzle.

### BRIEF DESCRIPTION OF THE DRAWINGS

FIG. 1 is an explanatory diagram illustrating a schematic configuration of a three-dimensional modeling system in a first embodiment.

FIG. 2 is a perspective view illustrating a schematic configuration of a screw.

FIG. 3 is a schematic plan view of a barrel.

FIG. 4 is a perspective view of a valve unit.

FIG. 5 is a perspective view of the valve unit.

FIG. 6 is a cross-sectional view illustrating a configuration of a flow rate adjusting unit and a suction unit.

FIG. 7 is an explanatory diagram illustrating operation of the valve unit of the flow rate adjusting unit.

FIG. 8 is an explanatory diagram illustrating the operation of the valve unit of the flow rate adjusting unit.

FIG. 9 is a side view of the barrel and the flow rate adjusting unit.

FIG. 10 is a perspective view of a heater unit.

FIG. 11 is a diagram illustrating a state in which the heater unit is coupled to a modeling unit.

FIG. 12 is a block diagram for explaining an electrical configuration of a first heating unit.

FIG. 13 is a perspective view of the first heating unit.

FIG. 14 is an explanatory diagram illustrating a schematic configuration of an injection molding device in a second embodiment.

### DESCRIPTION OF EMBODIMENTS

### A. First Embodiment

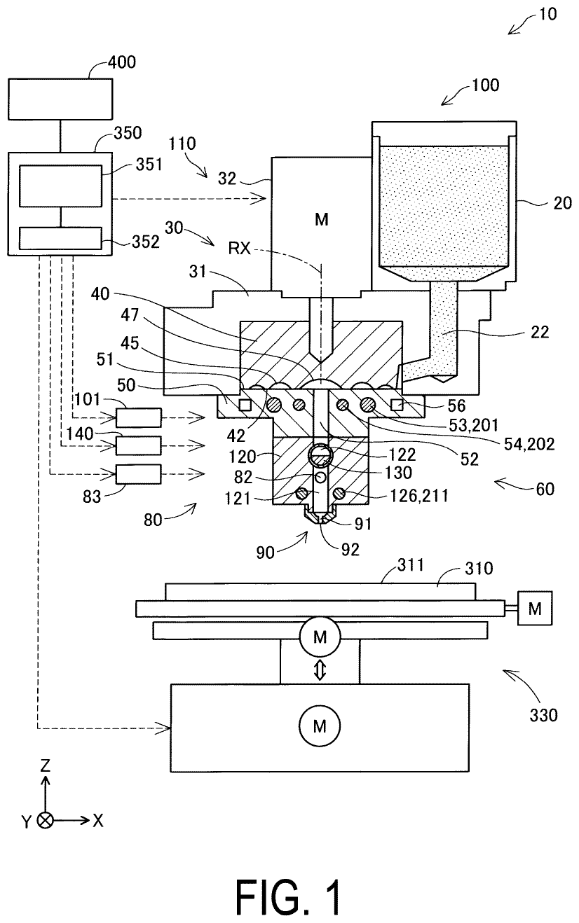

FIG. 1 is an explanatory diagram illustrating a schematic configuration of a three-dimensional modeling system 10 in a first embodiment. FIG. 1 illustrates arrows representing X, Y, and Z directions orthogonal to each other. The X direction and the Y direction are directions parallel to a horizontal plane. The Z direction is a direction parallel to a vertical direction. The X, Y, and Z directions in FIG. 1 and the X, Y, and Z directions in the other drawings indicate the same directions. When a direction is specified, a positive direction indicated by an arrow is referred to as “+”, a negative direction opposite to the direction indicated by the arrow is referred to as “−”, and positive and negative signs are used in combination for direction notation.

The three-dimensional modeling system 10 includes a three-dimensional modeling device 100 and an information processing device 400. The three-dimensional modeling device 100 of the embodiment is a device for molding an object by a material extrusion method. The three-dimensional modeling device 100 includes a control unit 350 for controlling each unit of the three-dimensional modeling device 100. The control unit 350 and the information processing device 400 are coupled so as to be able to communicate with each other.

The three-dimensional modeling device 100 includes a modeling unit 110 that generates and discharges a plasticized material, a stage 310 for modeling that serves as a base for a modeled object, and a moving mechanism 330 that controls a discharge position of the plasticized material.

Under the control of the control unit 350, the modeling unit 110 discharges the plasticized material obtained by plasticizing a material in a solid state onto the stage 310. The modeling unit 110 includes a material supply unit 20 that is a supply source of a raw material before being converted into the plasticized material, a plasticizing unit 30 that converts the raw material into the plasticized material, a nozzle 90 that discharges the plasticized material supplied from the plasticizing unit 30 toward the stage 310, a flow rate adjusting unit 60 that adjusts a flow rate of the plasticized material supplied from the plasticizing unit 30 to the nozzle 90, and a suction unit 80 that suctions the plasticized material. Note that “plasticization” is a concept including melting, and means changing a solid state to a fluid state. Specifically, in a case of a material in which glass transition occurs, the plasticization is to raise a temperature of the material to or above a glass transition point. In a case of a material in which glass transition does not occur, the plasticization is to raise a temperature of the material above a melting point thereof.

The material supply unit 20 supplies the material for generating the plasticized material to the plasticizing unit 30. The material supply unit 20 is configured by a hopper, for example. In the material supply unit 20, a pellet-like material containing metal powder obtained by powdering a metal material and a binder is accommodated. As the metal material, a single metal such as magnesium (Mg), iron (Fe), cobalt (Co), chromium (Cr), aluminum (Al), titanium (Ti), copper (Cu), or nickel (Ni), or alloy containing two or more of these metals is used. Examples of the aforementioned alloy include maraging steel, cobalt-chromium-molybdenum, a titanium alloy, a nickel alloy, an aluminum alloy, a cobalt alloy, a cobalt-chromium alloy, and the like. In other words, the material contains metal particles. The binder contains resin and wax. As the resin, polyolefins such as polyethylene, polypropylene, and ethylene-vinyl acetate copolymer, acrylic resins such as polymethyl methacrylate and polybutyl methacrylate, styrene resins such as polystyrene, polyvinyl chloride, polyvinylidene chloride, polyamide, polyesters such as polyethylene terephthalate and polybutylene terephthalate, polyether, polyvinyl alcohol, polyvinyl pyrrolidone, and copolymers thereof are used. A supply path 22 that couples the material supply unit 20 and the plasticizing unit 30 is provided below the material supply unit 20. The material supply unit 20 supplies the material to the plasticizing unit 30 via the supply path 22.

The plasticizing unit 30 plasticizes at least a part of the material in a solid state supplied from the material supply unit 20 to form the paste-like plasticized material having fluidity, and supplies the paste-like plasticized material to the nozzle 90. The plasticizing unit 30 includes a screw 40, a screw case 31, a driving motor 32, and a barrel 50.

The screw 40 is housed in the screw case 31. An upper surface side of the screw 40 is coupled to the driving motor 32. The screw 40 rotates around a rotation axis RX in the screw case 31 by rotational driving force generated by the driving motor 32. An axis line direction of the rotation axis RX of the screw 40 is a direction along the Z direction. A rotational speed of the screw 40 is controlled by the control unit 350 controlling a rotational speed of the driving motor 32. Note that the screw 40 may be driven by the driving motor 32 via a reduction gear. The screw 40 is also called a rotor or a flat screw.

The barrel 50 is disposed on a −Z direction side of the screw 40. A facing surface 51 which is an upper surface of the barrel 50 faces a groove-formed surface 42 which is a lower surface of the screw 40. A communication hole 52 that communicates with a supply flow path 121 of the flow rate adjusting unit 60 is formed at a center of the barrel 50. The barrel 50 is provided with a first hole 53 and a second hole 54. The first hole 53 and the second hole 54 each include a pair of holes provided so as to sandwich the communication hole 52. The second hole 54 is provided between the first hole 53 and the communication hole 52 in the X direction. That is, the second hole 54 is provided between the communication hole 52 and the first hole 53 when viewed in a direction along the rotation axis RX of the screw 40. A first heating unit 201 is accommodated in the first hole 53, and a second heating unit 202 is accommodated in the second hole 54. The first heating unit 201 and the second heating unit 202 heat the material supplied to a groove 45 of the screw 40. The first heating unit 201 and the second heating unit 202 are, for example, heaters. Temperatures of the first heating unit 201 and the second heating unit 202 are controlled by the control unit 350. Specific configurations of the first heating unit 201 and the second heating unit 202 will be described later.

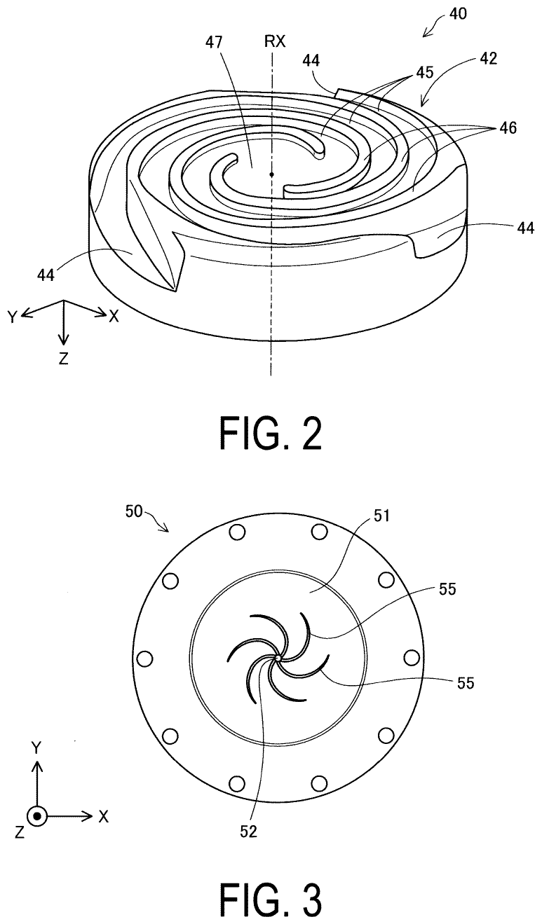

FIG. 2 is a perspective view illustrating a schematic configuration of the screw 40. The screw 40 has a length in the direction along the rotation axis RX being smaller than a length in a direction perpendicular to the rotation axis RX, and has a substantially cylindrical shape. The groove-formed surface 42 is formed with spiral-shaped grooves 45 around a central portion 47. The grooves 45 each communicate with a material inlet 44 formed at a side surface of the screw 40. The material supplied from the material supply unit 20 is supplied to the grooves 45 through the material inlets 44. The grooves 45 are formed by being separated by ridge portions 46. Although FIG. 2 illustrates an example in which three grooves 45 are formed, the number of grooves 45 may be one or two or more. Note that the groove 45 is not limited to the spiral shape, but may have a helical shape or an involute curve shape, or may have a shape extending from the central portion 47 toward an outer periphery so as to draw an arc.

FIG. 3 is a schematic plan view of the barrel 50. A plurality of guide grooves 55 are formed around the communication hole 52 at the facing surface 51. Each guide groove 55 has one end coupled to the communication hole 52, and spirally extends from the communication hole 52 toward an outer periphery of the facing surface 51. Note that the one end of the guide groove 55 need not be coupled to the communication hole 52. Further, the barrel 50 need not be formed with the guide groove 55.

The material supplied to the groove 45 of the screw 40 flows along the groove 45 while being plasticized in the groove 45 by the rotation of the screw 40 and the heating by the first heating unit 201 and the second heating unit 202, and is guided to the central portion 47 of the screw 40 as the plasticized material. The paste-like plasticized material exhibiting fluidity flowing into the central portion 47 is supplied to the flow rate adjusting unit 60 through the communication hole 52. Note that in the plasticizing unit 30, all types of substances constituting the plasticized material need not be plasticized. It is sufficient that the plasticized material is converted to be in a state having fluidity as a whole by plasticizing at least some types of the substances constituting the plasticized material.

As illustrated in FIG. 1, a refrigerant pipe 56 through which a refrigerant flows is embedded in the barrel 50 at a position farther from the communication hole 52 than the first hole 53 and the second hole 54. The refrigerant pipe 56 is disposed so as to pass through a vicinity of an outer peripheral edge of the facing surface 51. The refrigerant pipe 56 is coupled to a refrigerant pump 101. The refrigerant pump 101 supplies the refrigerant to the refrigerant pipe 56. The refrigerant pump 101 is driven under the control of the control unit 350. As the refrigerant, for example, liquid such as water or oil, or a gas such as carbon dioxide can be used. It is possible to prevent temperatures of the screw 40 and the barrel 50 from becoming excessively high due to the refrigerant flowing through the refrigerant pipe 56. Note that the refrigerant pipe 56 and the refrigerant pump 101 may be referred to as a cooling unit.

The flow rate adjusting unit 60 adjusts a flow rate of the plasticized material flowing from the plasticizing unit 30 to the nozzle 90, that is, a flow rate of the plasticized material discharged from the nozzle 90. The flow rate adjusting unit 60 includes a main body portion 120, a valve unit 130, and a valve driving unit 140. The main body portion 120 is provided on the −Z direction side of the barrel 50. The main body portion 120 includes the supply flow path 121 which communicates with the communication hole 52 and a nozzle flow path 91 which will be described later, and an intersecting hole 122 which intersects the supply flow path 121. The valve unit 130 is disposed inside the intersecting hole 122, and adjusts the flow rate of the plasticized material flowing from the plasticizing unit 30 to the nozzle 90 by rotating in the intersecting hole 122. The valve unit 130 is driven by the valve driving unit 140 under the control of the control unit 350. The valve driving unit 140 is configured by, for example, a stepping motor. A specific configuration of the flow rate adjusting unit 60 will be described below. In the present specification, the flow rate adjusting unit 60 is also referred to as a flow rate adjusting device.

The suction unit 80 suppresses a tailing phenomenon in which the plasticized material drips from a nozzle opening 92 in a string-like manner by temporarily suctioning the plasticized material in the supply flow path 121 when the discharge of the plasticized material from the nozzle 90 is stopped. A specific configuration of the suction unit 80 will be described below.

The nozzle 90 is provided on the −Z direction side of the main body portion 120. The nozzle 90 includes the nozzle flow path 91 and the nozzle opening 92 provided at a front end of the nozzle 90. The nozzle flow path 91 communicates with the supply flow path 121 and the nozzle opening 92. The plasticized material flowing from the supply flow path 121 into the nozzle flow path 91 is discharged from the nozzle opening 92 toward the stage 310. In the present specification, the communication hole 52, the supply flow path 121, and the nozzle flow path 91 are also collectively referred to as a flow path.

The stage 310 is disposed at a position facing the nozzle opening 92 of the nozzle 90. In the first embodiment, a modeling surface 311 of the stage 310 facing the nozzle opening 92 is disposed so as to be parallel to the X and Y directions, that is, horizontal directions. The stage 310 may be provided with a stage heater for suppressing rapid cooling of a modeling material discharged onto the stage 310.

The moving mechanism 330 changes relative positions of the stage 310 and the nozzle 90 under the control of the control unit 350. In the embodiment, a position of the nozzle 90 is fixed, and the moving mechanism 330 moves the stage 310. The moving mechanism 330 includes a three-axis positioner that moves the stage 310 in three axis directions of the X, Y, and Z directions by driving force of three motors. In the present specification, unless otherwise specified, movement of the nozzle 90 means moving the nozzle 90 relative to the stage 310.

Note that in other embodiments, instead of the configuration in which the stage 310 is moved by the moving mechanism 330, a configuration may be employed in which the moving mechanism 330 moves the nozzle 90 relative to the stage 310 in a state in which the position of the stage 310 is fixed. In addition, a configuration in which the stage 310 is moved in the Z direction by the moving mechanism 330 and the nozzle 90 is moved in the X and Y directions, or a configuration in which the stage 310 is moved in the X and Y directions by the moving mechanism 330 and the nozzle 90 is moved in the Z direction may be employed. Even with these configurations, the relative positional relationship between the nozzle 90 and the stage 310 can be changed.

Although only one modeling unit 110 is illustrated in FIG. 1, the three-dimensional modeling device 100 may include a plurality of the modeling units 110. By providing the plurality of modeling units 110, different types of plasticized materials can be discharged from the respective modeling units 110. Therefore, for example, a main body of a modeled object and a support structure supporting the modeled object can be modeled using different types of plasticized materials.

The control unit 350 is a control device that controls overall operation of the three-dimensional modeling device 100. The control unit 350 is composed of a computer including one or more processors 351, a storage device 352 including a main storage device and an auxiliary storage device, and an input/output interface for performing input and output of signals with external parts, for example. By executing a program stored in the storage device 352, the processor 351 controls the modeling unit 110 and the moving mechanism 330 in accordance with modeling data acquired from the information processing device 400 to model an object above the stage 310. Note that the control unit 350 may be implemented by a configuration of a combination of circuits, not by the computer.

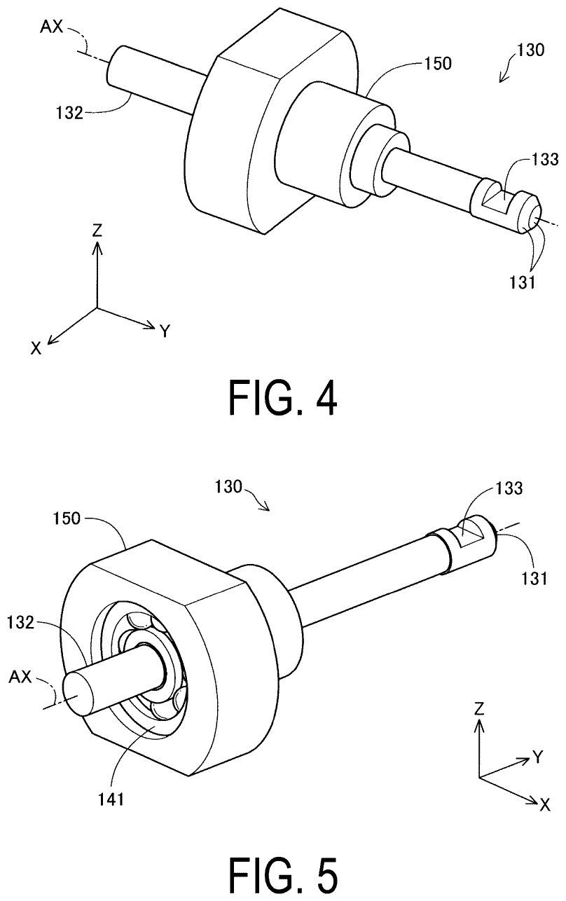

FIGS. 4 and 5 are perspective views of the valve unit 130. FIGS. 4 and 5 illustrate the valve unit 130 in a state of being supported by a support portion 150 described later. In the embodiment, the valve unit 130 is formed of high speed steel. Note that it is sufficient that the valve unit 130 is not limited to high speed steel, but is formed of a material having high hardness. The valve unit 130 may be formed of, for example, cemented carbide. The valve unit 130 has a shaft shape centered on a central axis AX. A direction along the central axis AX is the Y direction. The valve unit 130 includes a front end 131, a rear end 132, and a concave portion 133. The front end 131 is an end portion of the valve unit 130 on a +Y direction side, and the rear end 132 is an end portion of the valve unit 130 on a −Y direction side. The front end 131 is formed with a surface perpendicular to the Y direction and a portion obtained by chamfering a corner portion of the cylindrical valve unit 130. Note that the front end 131 need not be formed with the portion obtained by chamfering the corner portion of the cylindrical valve unit 130.

The valve driving unit 140 is coupled to the rear end 132. When torque generated by the valve driving unit 140 is applied to the rear end 132, the valve unit 130 rotates around the central axis AX.

The concave portion 133 is provided by cutting out a part of a side surface of the cylindrical valve unit 130 in a half-moon shape. The concave portion 133 is provided in a vicinity of the front end 131. A distance along the Y direction from the front end 131 to the concave portion 133 is shorter than a distance along the Y direction from the rear end 132 to the concave portion 133. Note that the concave portion 133 may be provided by forming a through-hole intersecting the central axis AX of the valve unit 130.

The support portion 150 supports a part of the side surface of the valve unit 130 between the rear end 132 and the concave portion 133. The valve unit 130 is supported by the support portion 150 via a ball bearing 141. Thus, the valve unit 130 can smoothly rotate around the central axis AX.

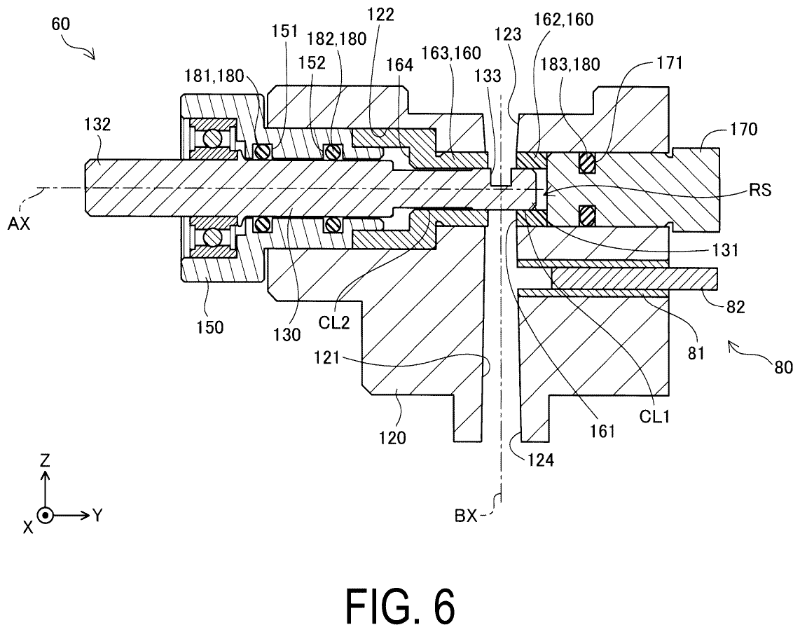

FIG. 6 is a cross-sectional view illustrating a configuration of the flow rate adjusting unit 60 and the suction unit 80. FIG. 6 illustrates the valve unit 130 in a state of being accommodated in the main body portion 120.

In the embodiment, the supply flow path 121 is a flow path penetrating the main body portion 120 in the Z direction. The supply flow path 121 is formed with a first opening 123 through which the plasticized material is supplied from the communication hole 52, and a second opening 124 through which the plasticized material is ejected to the nozzle flow path 91. In addition, in the embodiment, the intersecting hole 122 is a hole penetrating the main body portion 120 in the Y direction. The valve unit 130 is disposed inside the intersecting hole 122 so that the concave portion 133 overlaps the supply flow path 121. In other words, the concave portion 133 is formed at a position overlapping the supply flow path 121.

The flow rate adjusting unit 60 further includes the support portion 150, a sleeve 160, a lid portion 170, and a seal portion 180. The support portion 150, the sleeve 160, and the lid portion 170 are accommodated in the intersecting hole 122 and are fixed to the main body portion 120 by press-fitting. A part of the valve unit 130 is disposed inside the sleeve 160. A part of the valve unit 130 is disposed inside the support portion 150. The lid portion 170 is disposed on the +Y direction side with respect to the front end 131 of the valve unit 130 in the intersecting hole 122.

The support portion 150 is a tubular member. The support portion 150 supports the valve unit 130 as described above. The support portion 150 is disposed at a position closer to the rear end 132 of the valve unit 130 than the sleeve 160, that is, on the −Y direction side with respect to the sleeve 160. When a direction from the front end 131 toward the rear end 132 of the valve unit 130 is defined as a first direction, the support portion 150 is disposed adjacent to the sleeve 160 in the first direction. In the embodiment, the first direction is the −Y direction. A surface of the support portion 150 facing the valve unit 130 is formed with a first seal groove 151 and a second seal groove 152. Shapes of the first seal groove 151 and the second seal groove 152 are annular on respective planes perpendicular to the central axis AX of the valve unit 130. The first seal groove 151 is formed on the −Y direction side with respect to the second seal groove 152.

The sleeve 160 is a tubular member. The sleeve 160 is disposed at a position closer to the front end 131 of the valve unit 130 than the support portion 150, that is, on the +Y direction side with respect to the support portion 150, and covers the front end 131 of the valve unit 130 and the concave portion 133. An end portion of the support portion 150 on the +Y direction side is press-fitted into an end portion of the sleeve 160 on the −Y direction side. The sleeve 160 is provided with a through-hole 161 along the Z direction at a position overlapping the supply flow path 121. The sleeve 160 includes a first portion 162 and a second portion 163. The first portion 162 is a portion of the sleeve 160 located on the +Y direction side with respect to a central axis BX of the supply flow path 121. The second portion 163 is a portion of the sleeve 160 located on the −Y direction side with respect to the central axis BX of the supply flow path 121. A direction along the central axis BX of the supply flow path 121 is the Z direction. The first portion 162 is provided to be replaceable. The first portion 162 is formed of a material having lower hardness than the second portion 163. Specifically, the first portion 162 is formed of polyamide-imide, and the second portion 163 is formed of high speed steel. Note that the first portion 162 is not limited to polyamide-imide, but may be formed of plastic such as polyimide or polyphenylene sulfide. The second portion 163 is not limited to high speed steel and may be formed of metal such as cemented carbide or SUS. The first portion 162 and the second portion 163 may be formed of a material having heat resistance.

The lid portion 170 is a cylindrical member. The lid portion 170 is provided on the +Y direction side with respect to the front end 131 of the valve unit 130 in the intersecting hole 122. The lid portion 170 seals an opening on the +Y direction side of the intersecting hole 122. An end portion of the sleeve 160 on the +Y direction side is in contact with the lid portion 170. A surface of the lid portion 170 facing the main body portion 120 is formed with a third seal groove 171. A shape of the third seal groove 171 is annular on a plane perpendicular to the central axis AX of the valve unit 130.

As illustrated in FIG. 6, an inner diameter of the end portion of the sleeve 160 on the −Y direction side is larger than an inner diameter of the end portion of the sleeve 160 on the +Y direction side. The valve unit 130 does not include a portion protruding in a direction intersecting the central axis AX of the valve unit 130 in the sleeve 160. Specifically, the valve unit 130 does not include a portion having a flange-like shape protruding so as to come into contact with a first inner surface 164 which is an inner surface of the sleeve 160. Here, the first inner surface 164 is an inner surface located at a portion where the inner diameter of the sleeve 160 changes, and is a surface perpendicular to the central axis AX.

The valve unit 130 and the support portion 150 are engaged with each other so as to be rotationally engaged or finely rotationally engaged with each other. The valve unit 130 and the sleeve 160 are fitted to each other so as to be rotationally engaged or finely rotationally engaged with each other. Therefore, clearances are provided between the valve unit 130 and the support portion 150 and between the valve unit 130 and the sleeve 160, respectively, so that the valve unit 130 is rotatable in the sleeve 160 and the support portion 150. In the present specification, of the clearance between the valve unit 130 and the sleeve 160, a portion from the front end 131 to the concave portion 133 is referred to as a first clearance portion CL1, and a portion from the concave portion 133 to the end portion of the support portion 150 on the +Y direction side is referred to as a second clearance portion CL2. The front end 131 of the valve unit 130, an inner wall surface of the sleeve 160, and the lid portion 170 define a storage chamber RS for storing the plasticized material in the intersecting hole 122. A part of the plasticized material flowing through the supply flow path 121 flows through the first clearance portion CL1 and is stored in the storage chamber RS.

The seal portion 180 includes a first seal portion 181, a second seal portion 182, and a third seal portion 183. Each seal portion 180 includes an O-ring. The first seal portion 181 is disposed in the first seal groove 151, the second seal portion 182 is disposed in the second seal groove 152, and the third seal portion 183 is disposed in the third seal groove 171. The first seal portion 181 and the second seal portion 182 prevent the plasticized material stored in the second clearance portion CL2 from leaking from a gap between the valve unit 130 and the support portion 150. The third seal portion 183 prevents the plasticized material stored in the storage chamber RS from leaking from a gap between the lid portion 170 and the main body portion 120.

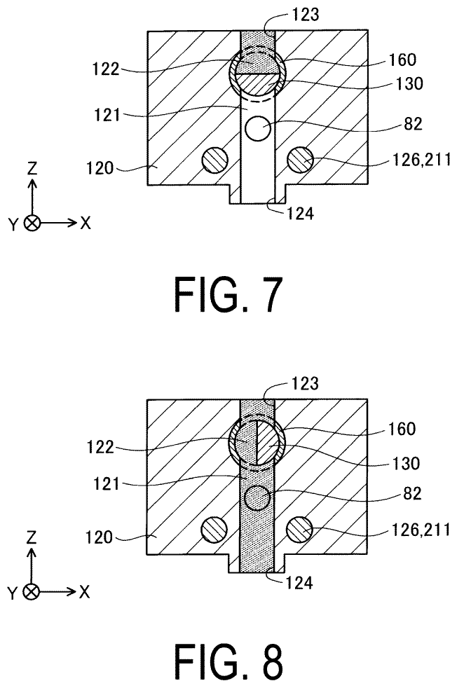

FIGS. 7 and 8 are explanatory diagrams illustrating operation of the valve unit 130 of the flow rate adjusting unit 60. As illustrated in FIG. 7, when the valve unit 130 rotates so that the concave portion 133 faces in the +Z direction, the supply flow path 121 is closed by the valve unit 130, and the flow of the plasticized material is blocked. On the other hand, as illustrated in FIG. 8, when the valve unit 130 rotates so that the concave portion 133 faces in a +X direction or a −X direction, the plasticized material passes through the supply flow path 121 at a maximum flow rate. That is, the valve unit 130 rotates around the central axis AX for changing a flow path cross-sectional area of the supply flow path 121, to change a position of the concave portion 133 for adjusting the flow rate of the plasticized material flowing through the supply flow path 121, that is, the flow rate of the plasticized material discharged from the second opening 124.

Hereinafter, the suction unit 80 will be described with reference to FIGS. 1 and 6. The suction unit 80 includes a cylindrical cylinder 81 embedded in the main body portion 120, a columnar plunger 82 accommodated in the cylinder 81, and a plunger driving unit 83. The cylinder 81 is coupled to the supply flow path 121 between the intersecting hole 122 and the second opening 124. The plunger 82 is driven by the plunger driving unit 83 under the control of the control unit 350. The plunger driving unit 83 is configured by, for example, a stepping motor, a rack-and-pinion mechanism that converts turning force of the stepping motor into a translational motion of the plunger 82, and the like.

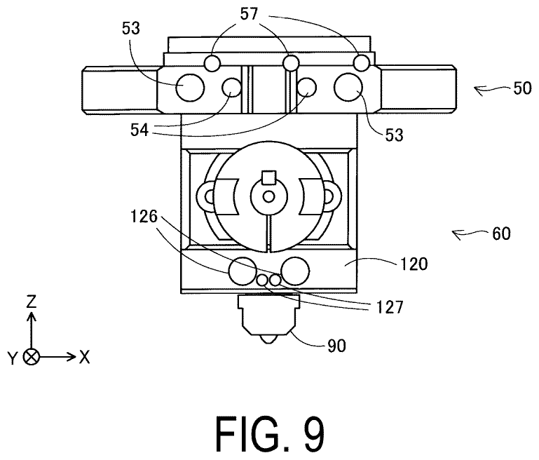

FIG. 9 is a side view of the barrel 50 and the flow rate adjusting unit 60. The barrel 50 is formed with the first hole 53 that accommodates the first heating unit 201, the second hole 54 that accommodates the second heating unit 202, and a third hole 57 that accommodates a first detection unit 203 to be described later. A diameter of the first hole 53 is larger than a diameter of the second hole 54. A direction in which the first hole 53 extends, a direction in which the second hole 54 extends, and a direction in which the third hole 57 extends coincide with each other. That is, an insertion direction of the first heating unit 201 into the first hole 53, an insertion direction of the second heating unit 202 into the second hole 54, and an insertion direction of the first detection unit 203 into the third hole 57 coincide with each other. In the embodiment, the direction in which the first hole 53, the second hole 54, and the third hole 57 extend is the Y direction. In the present specification, “coincide” also allows a state of being slightly inclined rather than completely matching. For example, when the diameter of the first hole 53 is larger than a diameter of the first heating unit 201, or when the diameter of the second hole 54 is larger than a diameter of the second heating unit 202, the direction in which the first hole 53 extends and the direction in which the second hole 54 extends may be slightly inclined.

In addition, the main body portion 120 is formed with a fourth hole 126 that accommodates a third heating unit 211 and a fifth hole 127 that accommodates a second detection unit 212 to be described later. A direction in which the fourth hole 126 extends and a direction in which the fifth hole 127 extends coincide with each other. That is, an insertion direction of the third heating unit 211 into the fourth hole 126 and an insertion direction of the second detection unit 212 into the fifth hole 127 coincide with each other. In the embodiment, the direction in which the fourth hole 126 and the fifth hole 127 extend is the Y direction. The direction in which the fourth hole 126 and the fifth hole 127 extend and the direction in which the first hole 53, the second hole 54, and the third hole 57 extend coincide with each other.

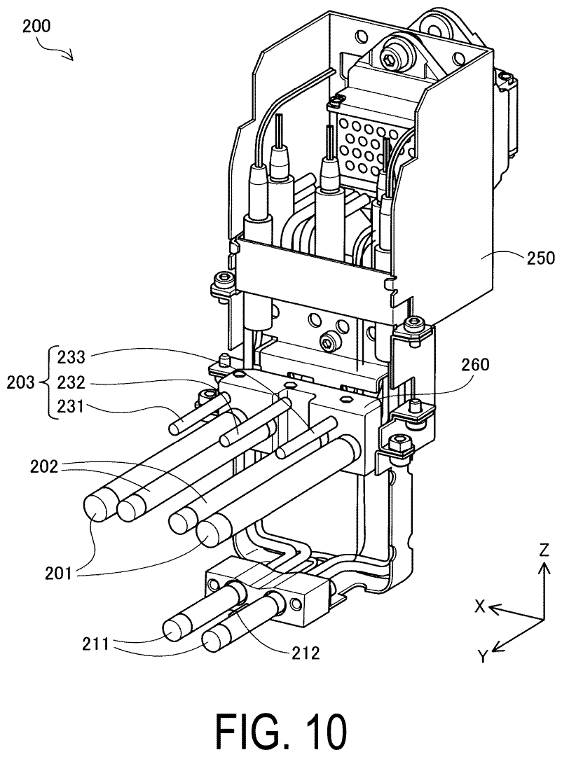

FIG. 10 is a perspective view of a heater unit 200. The heater unit 200 includes the first heating unit 201, the second heating unit 202, the first detection unit 203, the third heating unit 211, the second detection unit 212, and a fixing member 250. The first heating unit 201, the second heating unit 202, the first detection unit 203, the third heating unit 211, and the second detection unit 212 each have a columnar shape having an axis line along the Y direction, and are provided so as to protrude from the fixing member 250 in the +Y direction. The first heating unit 201, the second heating unit 202, the first detection unit 203, the third heating unit 211, and the second detection unit 212 are each fixed to the fixing member 250, and are linked by the fixing member 250. Wiring lines of the first heating unit 201, the second heating unit 202, the first detection unit 203, the third heating unit 211, and the second detection unit 212 are accommodated in the fixing member 250. The first heating unit 201, the second heating unit 202, and the third heating unit 211 each include a pair of heaters. The diameter of the first heating unit 201 is larger than the diameter of the second heating unit 202. The first detection unit 203 detects a temperature of the groove 45 of the screw 40. The second detection unit 212 detects a temperature of the main body portion 120. The first detection unit 203 and the second detection unit 212 are, for example, thermocouples. The first heating unit 201, the second heating unit 202, the first detection unit 203, the third heating unit 211, and the second detection unit 212 are provided at such positions that when the heater unit 200 is coupled to the modeling unit 110, the first heating unit 201 is inserted into the first hole 53, the second heating unit 202 is inserted into the second hole 54, the first detection unit 203 is inserted into the third hole 57, the third heating unit 211 is inserted into the fourth hole 126, and the second detection unit 212 is inserted into the fifth hole 127.

The first detection unit 203 includes a first sensor 231, a second sensor 232, and a third sensor 233. The first sensor 231, the second sensor 232, and the third sensor 233 are provided at the heater unit 200 in this order from the +X direction toward the −X direction. The first sensor 231 is located near an outer periphery of the facing surface 51 of the barrel 50, that is, near the first heating unit 201 in a state where the first detection unit 203 is inserted into the third hole 57. The first sensor 231 measures a temperature of a region closer to the first heating unit 201 than to the second heating unit 202. The temperature measured by the first sensor 231 is used to control the temperature of the first heating unit 201. The second sensor 232 is located near the communication hole 52, that is, near the second heating unit 202 in the state where the first detection unit 203 is inserted into the third hole 57. The second sensor 232 measures a temperature of a region closer to the second heating unit 202 than the first heating unit 201. The temperature measured by the second sensor 232 is used to control the temperature of the second heating unit 202. The third sensor 233 is used to monitor the temperature of the groove 45 of the screw 40. Before the heater unit 200 is assembled, the first sensor 231 and the first heating unit 201 are electrically coupled to each other, and the second sensor 232 and the second heating unit 202 are electrically coupled to each other.

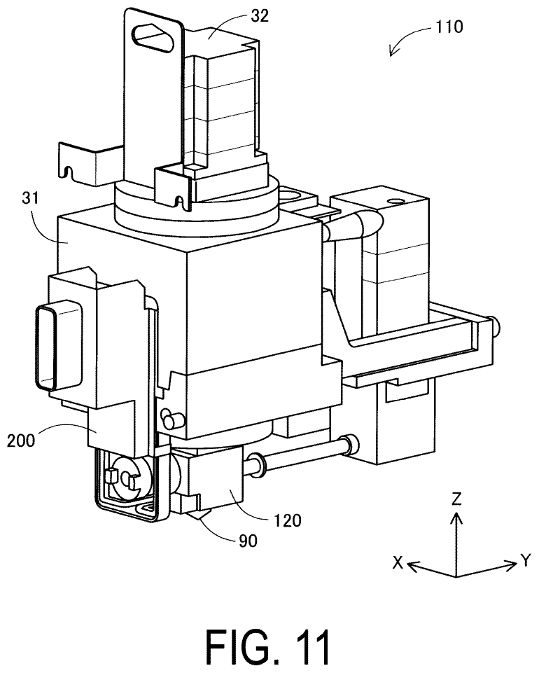

FIG. 11 is a diagram illustrating a state in which the heater unit 200 is coupled to the modeling unit 110. By coupling the heater unit 200 to the modeling unit 110, the first heating unit 201 is inserted into the first hole 53, the second heating unit 202 is inserted into the second hole 54, the first detection unit 203 is inserted into the third hole 57, the third heating unit 211 is inserted into the fourth hole 126, and the That is, by coupling the heater unit 200 to the modeling unit 110, the first heating unit 201, the second heating unit 202, and the first detection unit 203 are disposed in the barrel 50, and the third heating unit 211 and the second detection unit 212 are disposed in the main body portion 120. Accordingly, when viewed in a direction along the rotation axis RX, the second heating unit 202 is disposed between the first heating unit 201 and the communication hole 52.

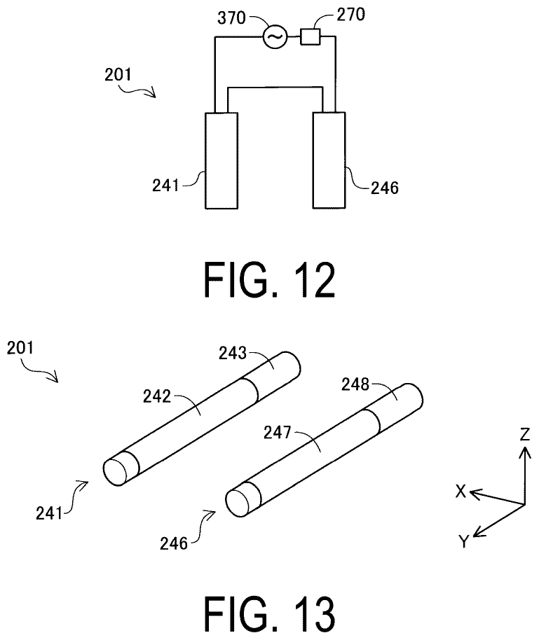

FIG. 12 is a block diagram for explaining an electrical configuration of the first heating unit 201. The first heating unit 201 includes a first heater 241 and a second heater 246. The first heater 241 and the second heater 246 are mutually electrically coupled in series to the control unit 350. FIG. 12 illustrates an AC power supply 370 included in the control unit 350 and serving as a power supply for operating the first heating unit 201. Further, the heater unit 200 includes a disconnection sensor 270. The disconnection sensor 270 detects disconnection of a circuit for operating the first heating unit 201. When disconnection of a circuit is detected by the disconnection sensor 270, the control unit 350 stops operation of the three-dimensional modeling device 100 and reports an error. Stopping the operation of the three-dimensional modeling device 100 specifically means stopping output of all the heaters and all the motors included in the three-dimensional modeling device 100. For example, the control unit 350 reports an error by outputting a warning sound from a notification unit included in the three-dimensional modeling device 100 or displaying a message on a display unit such as a liquid crystal display included in the three-dimensional modeling device 100. Similarly to the first heating unit 201, the second heating unit 202 includes two heaters mutually electrically coupled in series. The disconnection sensor 270 detects disconnection not only for the circuit for operating the first heating unit 201 but also for a circuit for operating the second heating unit 202.

FIG. 13 is a perspective view of the first heating unit 201. The first heater 241 includes a first heater heating unit 242 provided with a heater and a first heater non-heating unit 243 not provided with a heater. The first heater non-heating unit 243 is provided at a portion including an end portion of the first heater 241 on the −Y direction side, and the first heater heating unit 242 is provided adjacent to the first heater non-heating unit 243 on the +Y direction side. The first heater non-heating unit 243 is fixed to a block 260 of the heater unit 200, and the first heater heating unit 242 is inserted into the first hole 53 of the barrel 50. The second heater 246 includes a second heater heating unit 247 provided with a heater, and a second heater non-heating unit 248 not provided with a heater. The second heater non-heating unit 248 is provided at a portion including an end portion of the second heater 246 on the −Y direction side, and the second heater heating unit 247 is provided adjacent to the second heater non-heating unit 248 on the +Y direction side. The second heater non-heating unit 248 is fixed to the block 260 of the heater unit 200, and the second heater heating unit 247 is inserted into the first hole 53 of the barrel 50. Lengths in a longitudinal direction of the first heater 241 and the second heater 246, that is, lengths in the Y direction are equal to each other. In addition, lengths in the longitudinal direction of the first heater heating unit 242 and the second heater heating unit 247 are equal to each other, and lengths in the longitudinal direction of the first heater non-heating unit 243 and the second heater non-heating unit 248 are equal to each other. The first heater 241 and the second heater 246 are fixed to the block 260 so that positions in the Y direction of the first heater heating unit 242 and the second heater heating unit 247 protruding from the block 260 are equal to each other. Since the first heater 241 and the second heater 246 are disposed at symmetrical positions with respect to the communication hole 52 in a state of being inserted into the first hole 53 of the barrel 50, the barrel 50 can be heated symmetrically with respect to the communication hole 52. Note that the second heating unit 202 may have the same configuration as that of the first heating unit 201.

According to the first embodiment described above, the valve unit 130 of the flow rate adjusting unit 60 is disposed inside the sleeve 160. The valve unit 130 is formed of high speed steel, and the sleeve 160 includes the first portion 162 formed of polyamide-imide and the second portion 163 formed of high speed steel. That is, hardness of a surface of the sleeve 160 facing the valve unit 130 and hardness of a surface of the valve unit 130 facing the sleeve 160 are partially different from each other. In the embodiment, hardness of a part of the surface of the sleeve 160 facing the valve unit 130 is lower than hardness of the surface of the valve unit 130 facing the sleeve 160. Therefore, even when metal particles contained in the plasticized material enter between the valve unit 130 and the sleeve 160, the sleeve 160 is scraped by rotation of the valve unit 130 inside the sleeve 160, so that it is possible to prevent the rotation of the valve unit 130 inside the sleeve 160 from being hindered. Further, even when the metal particles contained in the plasticized material adhere to the valve unit 130, the sleeve 160 is scraped by the rotation of the valve unit 130 inside the sleeve 160, so that it is possible to prevent the rotation of the valve unit 130 inside the sleeve 160 from being hindered. The scraped sleeve 160 is replaced with a new sleeve 160. In the embodiment, the first portion 162 is replaced.

Additionally, in the embodiment, a surface of the lid portion 170 facing the main body portion 120 is formed with the third seal groove 171. The third seal portion 183 is disposed in the third seal groove 171. Therefore, it is possible to prevent the plasticized material stored in the storage chamber RS from leaking outside through a gap between the main body portion 120 and the lid portion 170.

Additionally, in the embodiment, the surface of the support portion 150 facing the valve unit 130 is formed with the first seal groove 151 and the second seal groove 152. The first seal portion 181 is disposed in the first seal groove 151, and the second seal portion 182 is disposed in the second seal groove 152. Therefore, it is possible to prevent the plasticized material stored in the second clearance portion CL2 from leaking outside from the gap between the valve unit 130 and the support portion 150.

In addition, in the embodiment, the plasticizing unit 30 includes the first heating unit 201 and the second heating unit 202 that heat the material supplied to the groove 45 of the screw 40. Since the diameter of the first heating unit 201 and the diameter of the second heating unit 202 are different from each other, it is possible to reduce a possibility that an operator erroneously disposes the first heating unit 201 and the second heating unit 202 when assembling the heater unit 200. Specifically, when the operator fixes the first heating unit 201 and the second heating unit 202 to the block 260 of the heater unit 200, it is possible to prevent positions of the first heating unit 201 and the second heating unit 202 from being reversed.

In addition, in the embodiment, the diameter of the first heating unit 201 is larger than the diameter of the second heating unit 202, and the diameter of the first hole 53 accommodating the first heating unit 201 is larger than the diameter of the second hole 54 accommodating the second heating unit 202. The first hole 53 is formed at a position further away from the communication hole 52 than the second hole 54. In addition, in the barrel 50, the refrigerant pipe 56 is embedded at a position further away from the communication hole 52 than the first hole 53. At a portion in a vicinity of the refrigerant pipe 56, the temperature of the barrel 50 is unlikely to rise. Therefore, by making the diameter of the first heating unit 201 accommodated in the first hole 53 close to the refrigerant pipe 56 larger than the diameter of the second heating unit 202 accommodated in the second hole 54 far from the refrigerant pipe 56, capacity of the heater located at an outer peripheral portion of the barrel 50 increases, and a temperature of the outer peripheral portion of the barrel 50 can be made higher.

In addition, in the embodiment, the pair of heaters constituting the first heating unit 201 are mutually electrically coupled in series and are electrically coupled to the control unit 350 that controls the temperature of the first heating unit 201. Therefore, when one of the heaters is disconnected, another heater is also stopped. Therefore, disconnection of the first heating unit 201 can be easily detected.

Further, in the embodiment, the valve unit 130 does not include a portion protruding in a direction intersecting the central axis AX of the valve unit 130 in the sleeve 160. Therefore, it is possible to prevent the rotation of the valve unit 130 in the sleeve 160 from being hindered by the metal particles entering between the above protruding portion and the sleeve 160.

### B. Second Embodiment

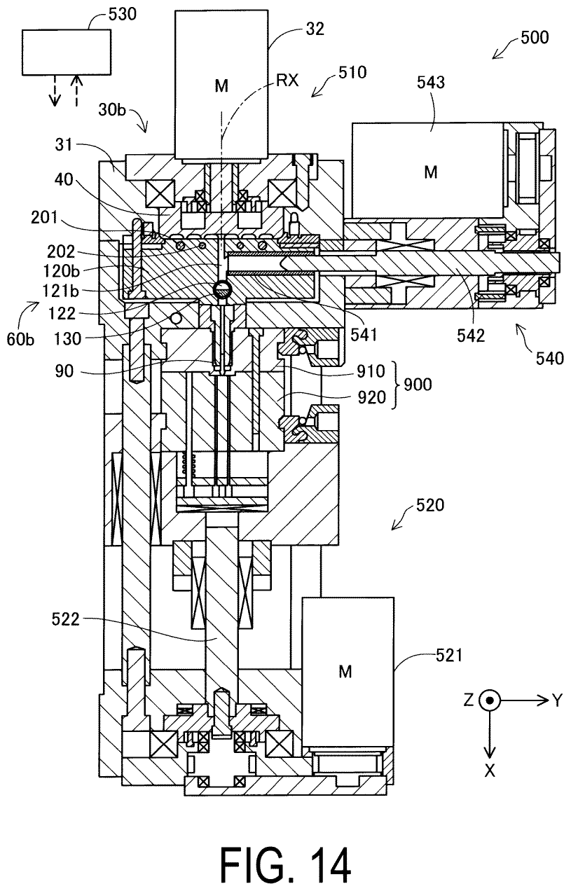

FIG. 14 is an explanatory diagram illustrating a schematic configuration of an injection molding device 500 in a second embodiment. In the second embodiment, a flow rate adjusting device is included in the injection molding device 500. The injection molding device 500 includes an injection unit 510, a mold clamping device 520, and a control unit 530. The injection unit 510 includes a plasticizing unit 30b, a flow rate adjusting unit 60b, a suctioning/feeding unit 540, and the nozzle 90. In the embodiment, elements denoted by the same reference numerals as those in the first embodiment are the same as those in the first embodiment. The flow rate adjusting device is provided between the plasticizing unit 30b and the nozzle 90.

The injection molding device 500 injects a plasticized material generated by the plasticizing unit 30b from the nozzle 90 into a molding die 900 to mold an object. Operation of the injection unit 510 and the mold clamping device 520 is controlled by control unit 530. The control unit 530 is configured as a computer including a CPU and a memory, and controls each unit of the injection molding device 500 by the CPU executing a program stored in the memory. Note that the control unit 350 may be configured by a circuit.

The molding die 900 includes a fixed die 910 and a movable die 920. The fixed die 910 is fixed to the injection unit 510. The movable die 920 is provided to be movable forward and backward in a mold clamping direction with respect to the fixed die 910 by the mold clamping device 520. The plasticized material generated by the plasticizing unit 30b is injected from the nozzle 90 into a cavity defined by the fixed die 910 and the movable die 920. The molding die 900 may be made of metal, may be made of resin, or may be made of ceramic. The metal molding die 900 is also referred to as a metal mold.

The mold clamping device 520 includes a die driving unit 521. The die driving unit 521 includes a motor, a gear, and the like, and is coupled to the movable die 920 via a ball screw 522. The mold clamping device 520 drives the die driving unit 521 under the control of the control unit 350 to rotate the ball screw 522, move the movable die 920 with respect to the fixed die 910, and open and close the molding die 900.

In the second embodiment, the barrel 50 and the main body portion 120 in the first embodiment are integrally provided as a main body portion 120b. In addition, the communication hole 52 and the supply flow path 121 in the first embodiment are integrally provided as a supply flow path 121b. Note that in the second embodiment, the barrel 50 and the main body portion 120 may be provided as separate bodies as in the first embodiment.

The suctioning/feeding unit 540 includes an injection cylinder 541, an injection plunger 542, and an injection plunger driving unit 543. The suctioning/feeding unit 540 has a function of injecting the plasticized material in the injection cylinder 541 into the molding die 900. The injection plunger 542 moves inside the injection cylinder 541 in a direction away from the supply flow path 121b to suction the plasticized material into the injection cylinder 541 for measurement. Thereafter, the injection plunger 542 moves inside the injection cylinder 541 in a direction approaching the supply flow path 121b to feed the plasticized material to the supply flow path 121b. The plasticized material fed to the supply flow path 121b is pressure-fed to the nozzle 90 and injected from the nozzle 90 into the molding die 900. The injection plunger 542 is driven by the injection plunger driving unit 543. The injection cylinder 541 is coupled to a portion of the supply flow path 121b that is closer to the screw 40 than the valve unit 130.

According to the second embodiment described above, similarly to the first embodiment, hardness of a part of the surface of the sleeve 160 facing the valve unit 130 is lower than hardness of the surface of the valve unit 130 facing the sleeve 160. Therefore, even when metal particles contained in the plasticized material enter between the valve unit 130 and the sleeve 160, the sleeve 160 is scraped by rotation of the valve unit 130 inside the sleeve 160, so that it is possible to prevent the rotation of the valve unit 130 inside the sleeve 160 from being hindered.

### C. Other Embodiments

(C-1) In the above embodiment, the hardness of a part of the surface of the sleeve 160 facing the valve unit 130 is lower than the hardness of the surface of the valve unit 130 facing the sleeve 160. On the other hand, the hardness of a part of the surface of the sleeve 160 facing the valve unit 130 may be higher than the hardness of the surface of the valve unit 130 facing the sleeve 160.

(C-2) In the above embodiment, the first portion 162 is the portion of the sleeve 160 located on the +Y direction side with respect to the central axis BX of the supply flow path 121, and the second portion 163 is the portion of the sleeve 160 located on the −Y direction side with respect to the central axis BX of the supply flow path 121. On the other hand, as long as the sleeve 160 includes the first portion 162 and the second portion 163, the positions of the first portion 162 and the second portion 163 are not limited to the above positions.

(C-3) In the above embodiment, the hardness of the surface of the sleeve 160 facing the valve unit 130 and the hardness of the surface of the valve unit 130 facing the sleeve 160 are partially different from each other. On the other hand, the hardness of the surface of the sleeve 160 facing the valve unit 130 and the hardness of the surface of the valve unit 130 facing the sleeve 160 may be different from each other as a whole.

(C-4) In the above embodiment, the surface of the support portion 150 facing the valve unit 130 is formed with the first seal groove 151 and the second seal groove 152. On the other hand, the surface of the support portion 150 facing the valve unit 130 need not be formed with a seal groove.

(C-5) In the above embodiment, the surface of the lid portion 170 facing the main body portion 120 is formed with the third seal groove 171. On the other hand, a surface of the main body portion 120 facing the lid portion 170 may be formed with the third seal groove 171. Further, both the surface of the lid portion 170 facing the main body portion 120 and the surface of the main body portion 120 facing the lid portion 170 may be formed with the third seal groove 171.

(C-6) In the above embodiment, the surface of the lid portion 170 facing the main body portion 120 is formed with the third seal groove 171. On the other hand, the surface of the lid portion 170 facing the main body portion 120 need not be formed with the third seal groove 171.

(C-7) In the above embodiment, the diameter of the first hole 53 is larger than the diameter of the second hole 54. On the other hand, the diameter of the first hole 53 may be smaller than the diameter of the second hole 54.

(C-8) In the above embodiment, the diameter of the first heating unit 201 is larger than the diameter of the second heating unit 202. On the other hand, the diameter of the first heating unit 201 may be smaller than the diameter of the second heating unit 202.

(C-9) In the above embodiment, the pair of heaters constituting the first heating unit 201 are mutually electrically coupled in series. On the other hand, the pair of heaters constituting the first heating unit 201 need not be mutually electrically coupled in series.

(C-10) In the above embodiment, the plasticizing unit 30 is included in the modeling unit 110. On the other hand, the plasticizing unit 30 may be included in the flow rate adjusting unit 60.

### D. Other Aspects

The present disclosure is not limited to the embodiments described above, and may be achieved in various aspects without departing from the spirits of the disclosure. For example, the present disclosure may be achieved through the following aspects. Appropriate replacements or combinations may be made to the technical features in the above-described embodiments which correspond to the technical features in the aspects described below to solve some or all of the problems of the disclosure or to achieve some or all of the advantageous effects of the disclosure. Further, even when technical characteristics are not described as essential ones in the present specification, it is possible to delete the technical characteristics in the embodiments appropriately.

(1) According to a first aspect of the present disclosure, a flow rate adjusting device is provided. The flow rate adjusting device includes a main body portion including a supply flow path formed with a first opening through which a plasticized material obtained by plasticizing at least a part of a material containing a metal particle is supplied and a second opening through which the plasticized material is ejected, and an intersecting hole intersecting the supply flow path, a tubular sleeve disposed inside the intersecting hole and including a through-hole at a position overlapping the supply flow path, and a shaft-shaped valve unit disposed inside the sleeve, wherein the valve unit includes a concave portion at a position overlapping the supply flow path, and rotates inside the intersecting hole for changing a position of the concave portion, to change a flow path cross-sectional area of the supply flow path for adjusting a flow rate of the plasticized material ejected from the second opening, and hardness of a surface of the sleeve facing the valve unit and hardness of a surface of the valve unit facing the sleeve are at least partially different from each other.

According to this aspect, even when the metal particles contained in the plasticized material enter between the valve unit and the sleeve, a member having lower hardness of the sleeve or the valve unit is scraped by rotation of the valve unit inside the sleeve, so that it is possible to prevent the rotation of the valve unit inside the sleeve from being hindered.

(2) The aspect described above may include a lid portion disposed in the intersecting hole and a seal portion, wherein the valve unit may include a front end and a rear end, a distance between the front end and the concave portion may be shorter than a distance between the rear end and the concave portion, a storage chamber for storing a part of the plasticized material may be defined in the intersecting hole by the front end and the lid portion, at least one of a surface of the lid portion facing the main body portion and a surface of the main body portion facing the lid portion may be formed with a seal groove, and the seal portion may be disposed in the seal groove.

According to this aspect, it is possible to prevent the plasticized material stored in the storage chamber from leaking outside through a gap between the main body portion and the lid portion.

(3) The aspect described above may include a tubular support portion disposed in the intersecting hole and a seal portion, wherein the valve unit, may include a front end and a rear end where a distance between the front end and the concave portion may be shorter than a distance between the rear end and the concave portion, need not include a portion protruding in a direction intersecting an axis line of the valve unit in the sleeve, when a direction from the front end toward the rear end is defined as a first direction, the support portion may be disposed adjacent to the sleeve in the first direction, a part of the valve unit may be disposed inside the support portion, a surface of the support portion facing the valve unit may be formed with a seal groove, and the seal portion may be disposed in the seal groove.

According to this aspect, it is possible to prevent the plasticized material supplied from the first opening from leaking outside from a gap between the valve unit and the support portion.

(4) The aspect described above may include a plasticizing unit configured to generate the plasticized material, wherein the plasticizing unit may include a screw that includes a groove-formed surface formed with a groove and rotates around a rotation axis, a barrel that includes a facing surface facing the groove-formed surface and is formed with a communication hole that supplies the plasticized material to the supply flow path, a first heating unit and a second heating unit that are disposed in the barrel and heat the material supplied to the groove, a first sensor that measures a temperature of a region closer to the first heating unit than the second heating unit, and a second sensor that measures a temperature of a region closer to the second heating unit than the first heating unit, when viewed in a direction along the rotation axis, the second heating unit may be disposed between the first heating unit and the communication hole, the barrel may be provided with a first hole that accommodates the first heating unit and a second hole that accommodates the second heating unit, a diameter of the first hole and a diameter of the second hole may be different from each other, and a diameter of the first heating unit and a diameter of the second heating unit may be different from each other.

According to this aspect, when an operator inserts the first heating unit and the second heating unit into the barrel, it is possible to prevent the first heating unit from being inserted into the second hole and the second heating unit from being inserted into the first hole.

(5) In the aspect described above, a diameter of the first heating unit may be smaller than a diameter of the second heating unit, and a diameter of the first hole may be larger than a diameter of the second hole.

According to this aspect, when an operator inserts the first heating unit and the second heating unit into the barrel, it is possible to prevent the first heating unit from being inserted into the second hole and the second heating unit from being inserted into the first hole.

(6) The aspect described above may include a control unit configured to control a temperature of the first heating unit, wherein the first hole may include a pair of holes provided with the communication hole interposed therebetween, the first heating unit may include a pair of heaters, and the pair of heaters may be mutually electrically coupled to the control unit in series.

According to this aspect, when any one of the heaters is disconnected, another heater is also stopped, and thus it is possible to easily detect disconnection of the first heating unit 201.

(7) According to a second aspect of the present disclosure, a three-dimensional modeling device is provided. The three-dimensional modeling device includes the flow rate adjusting device according to the above first aspect, a plasticizing unit configured to generate the plasticized material by plasticizing at least a part of the material, and a nozzle configured to discharge the plasticized material supplied from the plasticizing unit toward a stage, wherein the flow rate adjusting device adjusts a flow rate of the plasticized material supplied from the plasticizing unit to the nozzle.

According to this aspect, in the three-dimensional modeling device, even when the metal particles contained in the plasticized material enter between the valve unit and the sleeve, it is possible to prevent the rotation of the valve unit in the sleeve from being hindered.

(8) According to a third aspect of the present disclosure, an injection molding device is provided. The injection molding device includes the flow rate adjusting device according to the above first aspect, a plasticizing unit configured to generate the plasticized material by plasticizing at least a part of the material, and a nozzle configured to inject the plasticized material supplied from the plasticizing unit into a molding die, wherein the flow rate adjusting device adjusts a flow rate of the plasticized material supplied from the plasticizing unit to the nozzle.

According to this aspect, in the injection molding device, even when the metal particles contained in the plasticized material enter between the valve unit and the sleeve, it is possible to prevent the rotation of the valve unit in the sleeve from being hindered.

What is claimed is:

1. A flow rate adjusting device, comprising:
a main body portion including a supply flow path formed with a first opening through which a plasticized material obtained by plasticizing at least a part of a material including a metal particle is supplied and a second opening through which the plasticized material is ejected, and an intersecting hole intersecting the supply flow path;
a tubular sleeve disposed inside the intersecting hole and including a through-hole at a position overlapping the supply flow path; and
a shaft-shaped valve unit disposed inside the sleeve, wherein
the valve unit includes a concave portion at a position overlapping the supply flow path, and rotates inside the intersecting hole for changing a position of the concave portion, to change a flow path cross-sectional area of the supply flow path for adjusting a flow rate of the plasticized material ejected from the second opening, and
hardness of a surface of the sleeve facing the valve unit and hardness of a surface of the valve unit facing the sleeve are at least partially different from each other.

2. The flow rate adjusting device according to claim 1, comprising:
a lid portion disposed in the intersecting hole; and
a seal portion, wherein
the valve unit includes a front end and a rear end, and a distance between the front end and the concave portion is shorter than a distance between the rear end and the concave portion,
a storage chamber for storing a part of the plasticized material is defined in the intersecting hole by the front end and the lid portion,
at least one of a surface of the lid portion facing the main body portion and a surface of the main body portion facing the lid portion is formed with a seal groove, and
the seal portion is disposed in the seal groove.

3. The flow rate adjusting device according to claim 1, comprising:
a tubular support portion disposed in the intersecting hole; and
a seal portion, wherein
the valve unit
includes a front end and a rear end where a distance between the front end and the concave portion is shorter than a distance between the rear end and the concave portion, and
does not include a portion protruding in a direction intersecting an axis line of the valve unit in the sleeve,
when a direction from the front end toward the rear end is defined as a first direction, the support portion is disposed adjacent to the sleeve in the first direction,
a part of the valve unit is disposed inside the support portion,
a surface of the support portion facing the valve unit is formed with a seal groove, and
the seal portion is disposed in the seal groove.

4. The flow rate adjusting device according to claim 1, comprising a plasticizing unit configured to generate the plasticized material, wherein
the plasticizing unit includes
a screw that includes a groove-formed surface formed with a groove and rotates around a rotation axis,
a barrel that includes a facing surface facing the groove-formed surface and is formed with a communication hole that supplies the plasticized material to the supply flow path,
a first heating unit and a second heating unit that are disposed in the barrel and heat the material supplied to the groove,
a first sensor that measures a temperature of a region closer to the first heating unit than the second heating unit, and
a second sensor that measures a temperature of a region closer to the second heating unit than the first heating unit,
when viewed in a direction along the rotation axis, the second heating unit is disposed between the first heating unit and the communication hole,
the barrel is provided with a first hole that accommodates the first heating unit and a second hole that accommodates the second heating unit,
a diameter of the first hole and a diameter of the second hole are different from each other, and
a diameter of the first heating unit and a diameter of the second heating unit are different from each other.

5. The flow rate adjusting device according to claim 4, wherein
the diameter of the first heating unit is larger than the diameter of the second heating unit, and
the diameter of the first hole is larger than the diameter of the second hole.

6. The flow rate adjusting device according to claim 4, comprising a control unit configured to control a temperature of the first heating unit, wherein
the first hole includes a pair of holes provided with the communication hole interposed therebetween,
the first heating unit includes a pair of heaters, and
the pair of heaters are mutually electrically coupled to the control unit in series.

7. A three-dimensional modeling device, comprising:
the flow rate adjusting device according to claim 1;
a plasticizing unit configured to generate the plasticized material by plasticizing at least a part of the material; and
a nozzle configured to discharge the plasticized material supplied from the plasticizing unit toward a stage, wherein
the flow rate adjusting device adjusts a flow rate of the plasticized material supplied from the plasticizing unit to the nozzle.

8. An injection molding device, comprising:
the flow rate adjusting device according to claim 1;
a plasticizing unit configured to generate the plasticized material by plasticizing at least a part of the material; and
a nozzle configured to inject the plasticized material supplied from the plasticizing unit into a molding die, wherein
the flow rate adjusting device adjusts a flow rate of the plasticized material supplied from the plasticizing unit to the nozzle.
